(19) United States
(12) Patent Application Publication
(10) Pub. No.: US 2011/0029935 A1
(43) Pub. Date: Feb. 3, 2011

(54) METHOD AND APPARATUS FOR DETECTING UNDESIRED USERS USING SOCIALLY COLLABORATIVE FILTERING

(75) Inventors: Jennifer Snyder, Oakland, CA (US); John Toebes, Cary, NC (US); Brian P. Lawler, San Francisco, CA (US)

Correspondence Address: Patent Capital Group - Cisco, 6119 McCommas, Dallas, TX, 75214, US

(73) Assignee: CISCO TECHNOLOGY, INC., San Jose, CA (US)

(21) Appl. No.: 12/534,678

(22) Filed: Aug. 3, 2009

(51) Int. Cl. G06F 3/033; G06F 17/30

(52) U.S. Cl. 715/863

(57) ABSTRACT

In one embodiment, a method includes identifying at least one socially relevant gesture associated with a user and identifying at least one gesture graph that identifies content associated with at least one undesirable entity. The at least one socially relevant gesture is identified while the user is interacting with a system. The content includes a plurality of socially relevant gestures associated with the at least one undesirable entity. The method also includes determining when a distance between the at least one socially relevant gesture associated with the user and the content indicates that the user is undesirable, and processing the user as being undesirable when the distance indicates that the user is undesirable.

### FIELD OF TECHNOLOGY

The present invention relates generally to networking, and more particularly to content networking in enterprises.

### BACKGROUND

Online communities such as social networks are often accessed by undesirable users, or for purposes which are not legitimate. Such undesirable users, as well as robots, access content associated with online communities for purposes including, but not limited to including, posting undesired content, harassing legitimate users, and/or acting in an otherwise counterproductive manner. For example, an undesirable user may be a spammer who wishes to post spam on a message board of an online community.

Various methods are used by online communities in an effort to identify undesirable users. Some methods involve tracing Internet Protocol (IP) addresses of users to identify those addresses which have previously been used by undesirable users. Such methods may be time-consuming, as all traffic must be analyzed and compared to lists of suspicious IP addresses. Other methods involve assessing what a user has previously posted to an online community, and assessing whether a type of activity performed by a user is considered to be unusual, or not something a desirable user would do. Such methods may be difficult, as they require re-evaluation of users, and may allow undesirable users to repeatedly access an online community until enough information is gathered to allow the undesirable user to be identified. Still other methods involve relying on legitimate users to report those users that appear to be undesirable, and implementing CAPTCHAs or other tests designed to identify robots. Relying on users to report others may be effective, but the implementation of a system which uses human reporting may be expensive and relatively slow. While CAPTCHAs may be effective in preventing undesirable users from accessing an online community, CAPTCHAs may be defeated or otherwise broken by undesirable users.

### BRIEF DESCRIPTION OF THE DRAWINGS

The embodiments will be readily understood by the following detailed description in conjunction with the accompanying drawings in which:

FIG. 1 is a diagrammatic representation of a network in which socially collaborative filtering is used to identify suspicious users, e.g., spammers or griefers, in accordance with an embodiment of the present invention.

FIG. 2 is a process flow diagram which illustrates a general method of using socially collaborative filtering to identify undesirable users in accordance with an embodiment of the present invention.

FIG. 3A is a diagrammatic representation of a comparison between a gesture graph of a current user and a set of known gesture graphs at a time t1 in accordance with an embodiment of the present invention.

FIG. 3B is a diagrammatic representation of a comparison between a gesture graph of a current user and a set of known gesture graphs at a time t2, which is after a time t1, in accordance with an embodiment of the present invention.

FIG. 4 is a diagrammatic representation of a process of determining if a user is undesirable after the user gains access to an application in accordance with an embodiment of the present invention.

### DESCRIPTION OF EXAMPLE EMBODIMENTS

### General Overview

According to one aspect, a method includes identifying at least one socially relevant gesture associated with a user and identifying at least one gesture graph that identifies content associated with at least one undesirable entity. The at least one socially relevant gesture is identified while the user is interacting with a system. The content includes, but is not limited to including, a plurality of socially relevant gestures associated with the at least one undesirable entity. The method also includes determining when a distance between the at least one socially relevant gesture associated with the user and the content indicates that the user is undesirable, and processing the user as being undesirable when the distance indicates that the user is undesirable.

### Description

On social networks and other online communities, undesirable users often post undesired content, make unwanted contact with legitimate users, harass legitimate users, or otherwise behave in a counterproductive manner. Automatically identifying such undesirable users, e.g., fraudulent or non-legitimate users, who gain access to a system such as an online social network enables the damage or mischief caused by such users to effectively be mitigated. The actions of users may be processed substantially in real time, and compared to actions of known undesirable users in real time, to determine whether the users are undesirable.

Socially collaborative filtering may enable actions of users to be collected and processed to determine the status of the users. That is, socially collaborative filtering may allow a determination of whether users are legitimate or not legitimate, e.g., undesirable. In socially collaborative filtering, gestures may be weighted such that gestures are effectively prioritized, for example, based upon how those gestures relate to undesirable activity within a social network. Socially collaborative filtering may be used, in one embodiment, to identify users who behave similarly to a given user. If the users who behave similarly to a given user are undesirable, it may then effectively be inferred that the given user is also undesirable.

To affect socially collaborative filtering, socially relevant gestures made by users may be identified and collected. Socially relevant gestures may be those gestures or, more generally, actions that relate to how a user interacts with content. Socially relevant gestures may include, but are not limited to including, posting content such as blog posts, discussions, uploading media, updating user information such as a profile, commenting on a profile of a user of a social network, sending substantially direct messages to a user of a social network, rating posted content, flagging posted content, and/or logging into a social network. Such socially relevant gestures may be stored in a database that tracks the relationship between the user and the gestures. A user may take a range of actions on any piece of content, and may create a range of content. A socially relevant gesture may involve the type of interaction a user has with other users. Socially relevant gestures may generally include positive gestures, neutral gestures, and negative gestures.

Socially relevant gestures of a user may be tracked to identify a trend in behavior. Such a trend may then be compared to previously identified trends, or behaviors which exemplify undesirable users. If a behavioral trend of a user is a relatively close match to the behavioral trends of exemplary undesirable users or, conversely, if a behavioral trend of a user is a relatively distant match from the behavioral trends of exemplary legitimate users, then the user may be considered to be an undesirable user. Further, the behavioral trend of the user, if the user is identified as being an undesirable user, may be considered for future purposes to be a behavioral trend of an exemplary undesirable user.

In one embodiment, socially relevant gestures may be substantially collected from a user, and stored in a gesture graph that may then be compared with gesture graphs of known undesirable users in order to assess whether the user is likely to be an undesirable user. By collecting socially relevant gestures in real time as a user interacts with a system, e.g., a social networking system or other online community system, and then using those gestures in real time to determine whether the user is legitimate or not legitimate, undesirable users to be efficiently identified substantially in real time. Hence, even when an undesirable user gains access to a system, the access may be cancelled or otherwise withdrawn if the user is later identified as being undesirable. Thus, the damage or mischief caused by an undesirable user may be significantly reduced if the undesirable user may be identified substantially while the damage or mischief is being caused.

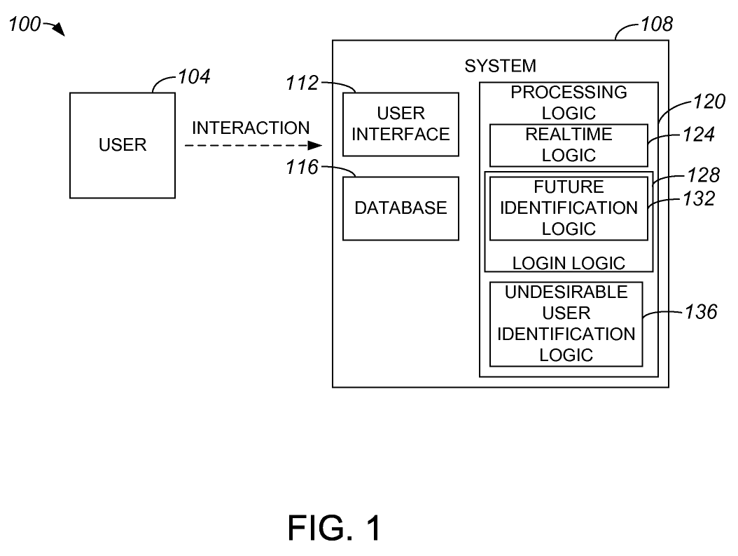

Referring initially to FIG. 1, a network which uses socially collaborative filtering to identify undesirable users will be described in accordance with an embodiment of the present invention. An overall network 100 includes a system 108 that may be accessed by a user 104. User 104 may be remote with respect to system 108, and may be configured to interact with system 108. System 108 may be a computing system or an enterprise computing environment.

User 104 may be a computing device that is operated by a human, or an automated computing device that substantially automatically attempts to access system 108. System 108 may be associated with a website, a social network community, and/or other online community.

When user 104 interacts with system 108, user 104 accesses a user interface 112. User interface 112 may generally be a graphical user interface which accepts input provided by user 104. System 108 includes a database 116 in which information relating to socially relevant gestures may be stored. By way of example, gesture graphs which contain data relating to socially relevant gestures performed by user 104 and other users who have accessed or attempted to access system 108 may be stored in database 116. Database 116 may be arranged to track relationships between users such as user 104 and their associated socially relevant gestures.

System 108 includes processing logic 120 that processes actions or gestures made by user 104, and also processes gesture graphs stored in database 116. In general, processing logic 120 is arranged to identify whether user 104 is undesirable, e.g., whether user 104 is engaging in fraudulent or otherwise unacceptable behavior.

Processing logic 120, which may be embodied as a processor, includes real time logic 124 that is configured to track gestures made by user 104 when user 104 accesses or attempts to access system 108. Login logic 128, which is also included in processing logic 120, is arranged to process user 104 when user attempts to log into or otherwise gain access to system 108. Login logic 128 may include CAPTCHAs or other tests which attempt to screen out undesirable users and to prevent undesirable users from gaining access to system 108. Login logic 128 may also include future identification logic 132 which is configured to prevent users previously identified as undesirable from accessing system 108 in the future. For example, if user 104 is identified as being undesirable, future identification logic 132 may prevent user 104 from being able to log into system 108 in the future.

Processing logic 120 also includes undesirable user identification logic 136. Undesirable user identification logic 136 is generally configured to compare socially relevant gestures of user 104 to socially relevant gestures of entities which have previously been identified as being undesirable. That is, undesirable user identification logic 136 is arranged to determine if user 104 is an undesirable user. Such a determination may be made using any suitable method, and may include, but is not limited to including, method which involve determining a distance between socially relevant gestures of user 104 and socially relevant gestures of entities previously identified as being undesirable. Undesirable user identification logic 136 may also track trends in socially relevant gestures to identify those socially relevant gestures which are common to a relatively large number of undesirable entities.

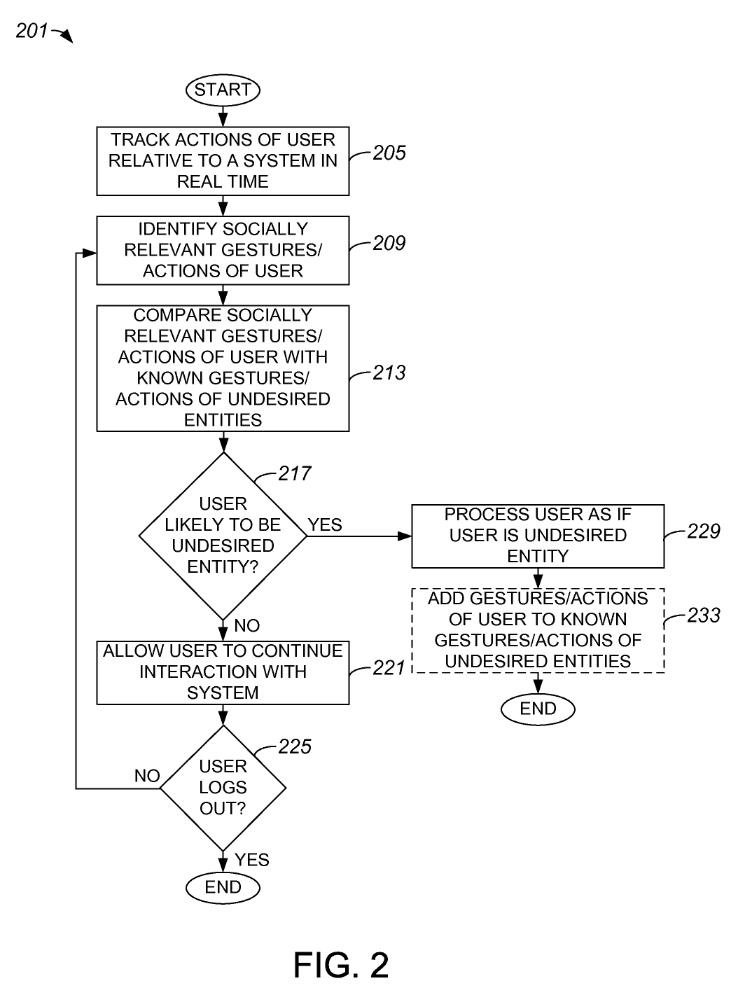

With reference to FIG. 2, one process of using socially collaborative filtering to identify to identify undesirable users that are currently accessing system, e.g., content in a system, will be described in accordance with an embodiment of the present invention. A process 201 of identifying if a user is undesirable begins at step 205 in which the actions, e.g., gestures, of the user are tracked by the system substantially in real time or dynamically once a user has gained access to the system. Gaining access to the system may include being granted authorization to access the system. By way of example, the actions of the user may be tracked by the system after the user successfully logs onto the system using socially collaborative filtering. Hence, when a user makes a post that should be blocked, that post may be identified substantially in real time, and blocked or removed. The system may identify content accessed by the user in real time, and may monitor interactions of the user either with the system or with other users through the system.

Users may include, but are not limited to including, an individual using a computing system, and/or robots, e.g., bots and spambots. Desirable users are generally legitimate users that are accessing the system for non-fraudulent, legitimate purposes. Undesirable users may generally be fake and/or fraudulent users that are accessing the system of purposes that are not legitimate. In one embodiment, undesirable users may also be legitimate users who are accessing the system at least in part for purposes that are not legitimate. Purposes that are not legitimate may include, but are not limited to including, spamming and “griefing.” As will be appreciated by those skilled in the art, spamming may involve abusing messaging systems by sending messages indiscriminately, while griefing may involve accessing a system, e.g., a computer gaming system, for the purposes of irritating and harassing other users of the system.

In the course of the system tracking the actions of the user in real time, the system identifies socially relevant actions of the user in step 209. The identified socially relevant actions may be stored, e.g., in a database in the format of a gesture graph. Socially relevant actions may typically include any actions defined by the system as being suitable for use in assessing whether a user is an undesirable entity. The definition of socially relevant actions may vary widely. For example, socially relevant actions may include, but are not limited to including, the use of certain keywords in postings to the system, the amount of time elapsed between current and previous posts, the posting of certain links, and both the misspelling of words and the number of occurrences of misspelled words in postings. Other information, such as demographic data of a user, an email address of the user, an Internet Protocol (IP) address from which a posting originates, the identification of the user, and the associations of the user may also be also effectively be considered as socially relevant actions.

After the socially relevant actions of the user are identified, the socially relevant actions are compared in step 213 to known actions of entities identified as being undesired. In one embodiment, comparing socially relevant actions of the user to know actions of undesired entities may include comparing a trend indicated in a gesture graph created based on the socially relevant actions of the user to trends in gesture graphs associated with known undesired entities. A comparison of socially relevant actions of the user with known actions of undesired entities is performed in real time, e.g., substantially while the user interacts with the system. Additionally, the known actions of the undesired entities may be updated in real time, as for example as undesired entities are identified. In other words, trends in behavior exhibited by undesired entities may be dynamically updated.

A determination is made in step 217 as to whether the user is likely to be an undesired entity. In one embodiment, such a determination involves determining whether the user is more likely to be an undesired entity or a desired entity based upon the comparison of socially relevant actions of the user against known actions of undesired entities. Determining whether the user is likely to be an undesired entity may include assessing how closely the trends associated with socially relevant actions of the user essentially match the trends associated with actions of known undesired entities, e.g., using distance engines. It should be appreciated that any suitable method may be used to determine the likelihood that the user is an undesired entity, and that thresholds used in such determinations may vary widely depending upon the specifications associated with the system.

If it is determined that the user is not likely to be an undesired entity, then the indication may be that the gesture graph associated with the socially relevant actions of the user is not a relatively strong match to the gesture graphs associated with undesired entities. Accordingly, process flow moves from step 217 to step 221 in which the system allows the user to continue to interact with the system. Then, in step 225, it is determined whether the user has logged out of the system. If the determination is that the user has not logged out, process flow returns to step 209 in which the socially relevant actions of the user are identified. Alternatively, if it is determined that the user has logged out in step 225, the process of identifying whether a user is undesirable is completed. It should be appreciated that the act of the user logging in, as well as the act of the user logging out, may be considered to be a socially relevant action. For an embodiment in which logging in and logging out may be socially relevant actions, a user that logs in or logs out may effectively be identified using a cookie and/or an IP address.

Returning to step 217, if it is determined that the user is likely to be an undesired entity, then the user is processed as if the user is an undesired entity in step 229. Processing the user as an undesired entity may include, but is not limited to including, quarantining the user, effectively locking the user out of the system, flagging or tagging the user as being undesirable but allowing the user to continue interacting with the system, and/or notifying a system administrator to review the actions of the user. Quarantining a user may include routing the user to a fake site associated with the system, and allowing the user to interact with the fake site.

After processing the user as an undesired entity, process flow moves to optional step 233 in which the actions of the user are essentially added as known actions of undesired entities. That is, the actions of the user may effectively be recorded as known actions of undesired entities. By way of example, a gesture graph associated with the user may be added to a database of gesture graphs associated with known undesired entities. The process of identifying an undesirable user is completed after the user is processed as an undesired entity, or, optionally, after the actions of the user are effectively recorded as known actions of undesired entities.

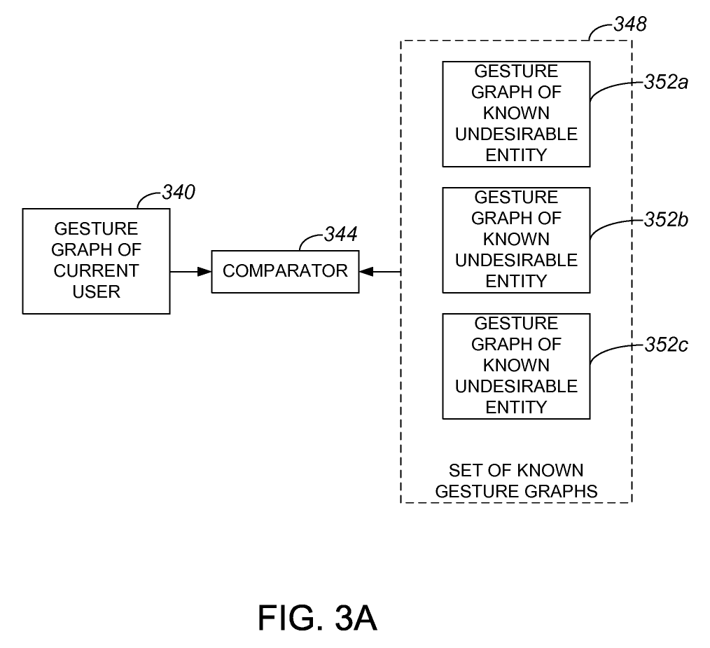

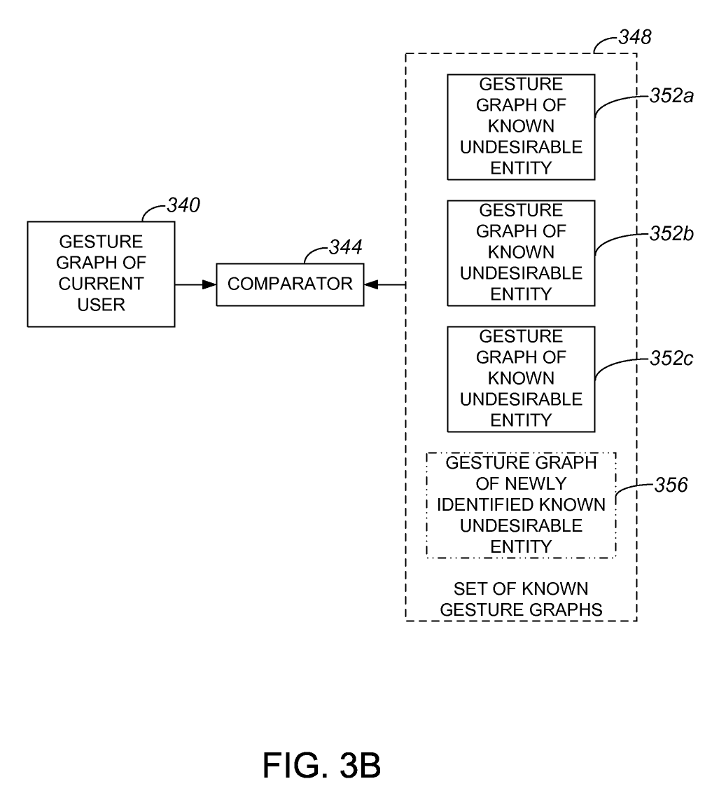

When a user has interacted with a system, e.g., in order to view or otherwise obtain content associated with the system, long enough such that a gesture graph or the like may be formed based upon the interactions, such a gesture graph may be compared to a set of gesture graphs know to the system. In other words, a gesture graph generated substantially in real time based on the actions of a user may be compared to gesture graphs of entities which have previously been identified as undesirable. Such a comparison may occur periodically, in one embodiment, during the course of the user interacting with the system. FIG. 3A is a diagrammatic representation of a comparison between a gesture graph of a current user and a set of known gesture graphs at a time t1 in accordance with an embodiment of the present invention. At a time t1, a gesture graph 340 of a current user is obtained and compared with a set of known gesture graphs 348 that include gesture graphs 352a-c associated with known undesirable entities.

Gesture graph 340 of the current user may be obtained by a system by effectively compiling, or otherwise processing, information relating to actions or gestures made by the current user while the user has been interacting with the system. For example, gesture graph 340 may effectively include information that identifies actions undertaken by the current user beginning substantially at the time the current user accessed the system. In one embodiment, socially collaborative filtering may be used to collect socially relevant gestures made by a user, and to store such gestures into gesture graph 340.

Set of known gesture graphs 348 is shown as included gesture graphs 352a-c of known undesirable entities. Such gesture graphs 352a-c may generally be associated with undesirable entities which have previously attempted to post content which has been blocked. It should be appreciated, however, that set of known gesture graphs 348 may additionally include gesture graphs (not shown) of known desirable entities. In general, set of known gesture graphs 348 may be embodied as data files stored on a storage medium such as a random access memory, database, and/or any suitable storage structure.

A comparator 344 may include hardware and/or software logic configured to obtain gesture graph 340 of the current user and to compare gesture graph 340 against set of known gesture graphs 348. When comparator 344 compares gesture graph 340 of the current user to gesture graphs 352a-c included in set of known gesture graphs 348, compare may identify whether gesture graph 340 of the current user is an approximately exact match to any of gesture graphs 352a-c included in set of known gesture graphs 348. Alternatively, comparator 344 may compare gesture graph 340 of the current user to gesture graphs 352a-c included in set of known gesture graphs 348 to determine how closely gesture graph 340 of the current user matches each gesture graph 352a-c. In one embodiment, if comparator 344 determines that gesture graph 340 of the current user matches more than a threshold percentage of any gesture graph 352a-c of set of known gesture graphs 348, then gesture graph 340 of the current user may be identified as indicating that the current user is likely an undesirable user or entity. Typically, comparator 344 identifies any close-distance relationships between gesture graph 340 of the current user and gesture graphs 352a-c of set of known gesture graphs 348. Any suitable distance engine may generally be used to identify close-distance relationships.

When a current user is identified as likely being an undesirable entity, the current user may be processed as being undesirable. On the other hand, when the current user is not identified as likely being an undesirable entity, the current user may continue to interact with the system, and gesture graph 340 of the current user may be updated in real time to include gestures of the current user that are made after time t1.

Set of known gesture graphs 348 may be updated periodically, as for example when a new undesirable entity is identified and the gesture graph (not shown) of the new undesirable entity is added to set of known gesture graphs 348. That is, after time t1, set of known gesture graphs 348 may be updated to include a gesture graph of a newly identified undesirable entity is obtained. As such, at a time t2, which is after the time at which a new gesture graph is added to set of known gesture graphs 348, gesture graph 340 of the current user may be compared once again to set of known gesture graphs 348. It should be appreciated that, typically, at time t2, gesture graph 340 of current user may include additional information than included in gesture graph 340 of current user at previous time t2. Such additional information may be associated with actions or gestures made by the current user between time t1 and time t2.

Referring next to FIG. 3B, a comparison between gesture graph 340 of the current user and set of known gesture graphs 348 which occurs at time t2 will be described in accordance with an embodiment of the present invention. At time t2, a current user is still interacting with a system, and gesture graph 340 of the current user continues to be updated substantially in real time. Gesture graph 340 of the current user may be provided to comparator 344 such that comparator 344 may compare gesture graph 340 of the current user against set of known gesture graphs 348. Set of known gesture graphs 348 includes gesture graphs 352a-c, as well as a gesture graph 356 of a newly identified known undesirable entity. Gesture graph 356 may be stored into set of known gesture graphs 348 between time t1 and time t2.

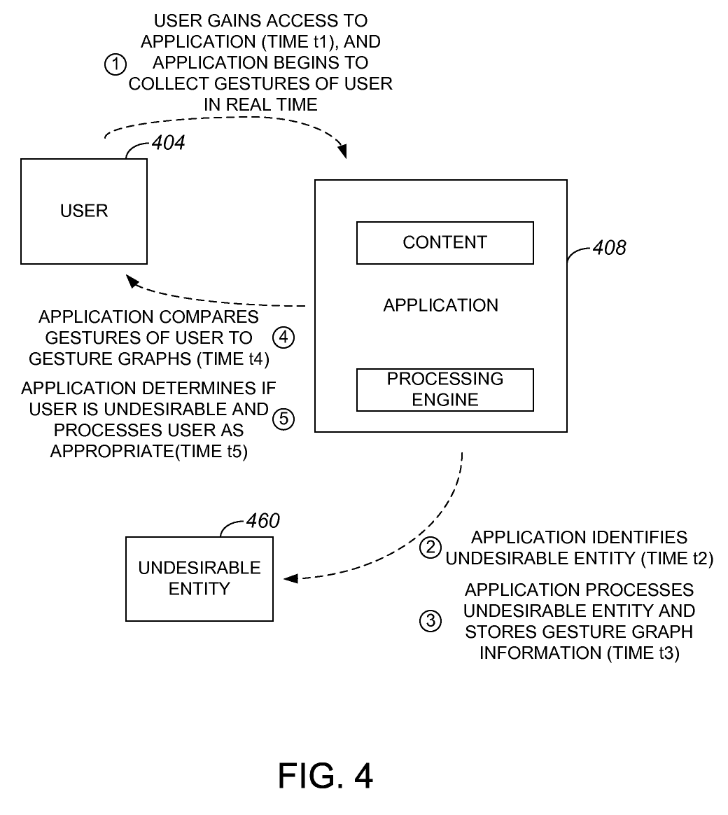

In general, a system that is associated with a social network or other online community may monitor substantially all users such that undesirable users may be identified and, hence, processed substantially in real time. Once a user is initially approved to access the system, the system monitors the user's actions and may periodically make determinations as to whether the user is actually an undesired user. FIG. 4 is a diagrammatic representation of a process of determining if a user is undesirable after the user gains access to a system, or an application, in accordance with an embodiment of the present invention. A user 404 may gain access to an application 408 such that user 404 may access content associated with application 408 at a time t1. Upon gaining access to application 408, e.g., upon successfully passing a screening process implemented by application 408, user 404 may interact with application 408. Application 408 may generally have a web page that user 404 may access in order to interact with application 408. While user 404 interacts with application 408, application 408 may collect or record the gestures made by or actions taken by user 404 approximately in real time.

In the described embodiment, at a time t2, application 408 identifies an undesirable entity 460. Any suitable method may generally be used to identify undesirable entity 460. At a time t3, application 408 processes undesirable entity 460, and stores a gesture graph that contains information relating to the gestures made by or actions taken by undesirable entity 460.

Application 408 may be arranged to periodically determine whether user 404 is undesirable. Determining whether user 404 is undesirable may include periodically traversing a set of gesture graphs to identify whether data contained in a gesture graph for user 404 is similar to content contained in any gesture graphs of the set of gesture graphs. Alternatively, application 408 may determine whether user 404 is undesirable after user 404 has made a predetermined number of gestures. When user 404 is checked for undesirability after a predetermined number of gestures is made, if user 404 creates a relatively large amount of activity, user 404 may be checked for desirability more frequently than if user 404 creates a relatively small amount of activity.

At a time t4, application 408 compares gestures of user 404 to gesture graphs. Then, at a time t5, application 408 determines if user 404 is undesirable, and processes user 404 as appropriate. By way of example, if data contained in a gesture graph of user 404 is determined to be similar to content contained in a gesture graph of a known undesirable entity such as undesirable entity 460, then user 404 may be processed as being undesirable. Processing user 404 as being undesirable may include, but is not limited to including, substantially quarantining user 404 or otherwise preventing user 404 from continuing to access application 408.

Although only a few embodiments of the present invention have been described, it should be understood that the present invention may be embodied in many other specific forms without departing from the spirit or the scope of the present invention. By way of example, a system or an application is not limited to being associated with a social network or online community. A system or an application may generally be associated with any content that a user may wish to access, and that may derive a benefit from the identification of fake, fraudulent, or otherwise undesired entities.

When a gesture graph of a current user is compared to gesture graphs of known undesirable entities, the current user may be considered to be undesirable of the contents of the gesture graph of the current user matches more than a threshold percentage of the contents of any one of the gesture graphs of known undesirable entities, as discussed above. In general, the comparison of gesture graphs is not limited to determining whether the contents of a gesture graph of a current user match more than a threshold percentage of the contents of a gesture graph of a known undesirable entity. For instance, if a gesture graph of a current user includes at least one particular action that is common to a predetermined percentage of the gesture graphs of known undesirable entities, the current user may be identified as likely being undesirable. By way of example, if a relatively high percentage of undesirable entities perform a particular action and the gesture graph of a current user indicates that the current user has performed and/or is performing the that particular action, the current user may be identified as likely being an undesirable entity.

The embodiments of the present invention may be implemented as hardware and/or software logic embodied in a tangible medium that, when executed, is operable to perform the various methods and processes described above. That is, the logic may be embodied as physical arrangements or components. For example, a processing engine may include physical components that maintains and compares gesture graphs to identify undesired users. A tangible medium may be substantially any computer-readable medium that is capable of storing logic which may be executed, e.g., by a computing system, to perform methods and functions associated with the embodiments of the present invention. The logic stored on a computer-readable medium may include computer code or computer program devices. In general, a computer-readable medium and computer code embodied thereon may effectively form a computer program product.

The steps associated with the methods of the present invention may vary widely. Steps may be added, removed, altered, combined, and reordered without departing from the spirit of the scope of the present invention. For example, in lieu of adding a gesture graph associated with a newly identified undesirable user to a database of gesture graphs associated with undesirable entities, the gestures or actions of the newly identified undesirable user may instead be incorporated into statistical calculations relating to gestures made by undesirable entities. In general, gestures may be recorded in a graph form without being stored in a database, although gestures may also be stored in a database. Therefore, the present examples are to be considered as illustrative and not restrictive, and the invention is not to be limited to the details given herein, but may be modified within the scope of the appended claims.

What is claimed is:

1. A method comprising:
identifying at least one socially relevant gesture associated with a user, the at least one socially relevant gesture associated with the user being identified while the user is interacting with a system;
identifying at least one gesture graph that identifies content associated with at least one undesirable entity, the content including a plurality of socially relevant gestures associated with the at least one undesirable entity;
determining when a distance between the at least one socially relevant gesture associated with the user and the content indicates that the user is undesirable; and
processing the user as being undesirable when the distance indicates that the user is undesirable.

2. The method of claim 1 wherein determining the distance between the at least one socially relevant gesture associated with the user and the content includes identifying a first trend associated with the at least one socially relevant gesture associated with the user, identifying a second trend associated with the content, and comparing the first trend with the second trend.

3. The method of claim 1 wherein determining the distance between the at least one socially relevant gesture associated with the user and the content includes comparing the at least one socially relevant gesture associated with the user to the at least one gesture graph that identifies the plurality of socially relevant gestures.

4. The method of claim 1 further including:
obtaining the at least one socially relevant gesture associated with the user; and
creating a first gesture graph, the first gesture graph being configured to include the at least one socially relevant gesture associated with the user, wherein determining the distance between the at least one socially relevant gesture associated with the user and the content includes comparing the first gesture graph with the at least one gesture graph that identifies content associated with the at least one desirable entity.

5. The method of claim 4 further wherein obtaining the at least one socially relevant gesture associated with the user includes obtaining the at least one socially relevant gesture associated with the user in real time, and wherein determining when the distance between the at least one socially relevant gesture associated with the user and the content includes determining when the distance between the at least one socially relevant gesture associated with the user and the content dynamically.

6. The method of claim 1 wherein processing the user as being undesirable when the distance indicates that the user is undesirable includes preventing the user from accessing the system.

7. The method of claim 1 wherein the at least one gesture graph that identifies content associated with the at least one desirable entity is included in a set of gesture graphs that identify undesirable entities, the method further including:
creating a first gesture graph associated with the user, the first gesture graph including the at least one socially relevant gesture associated with the user; and
adding the first gesture graph to the set of gesture graphs when the distance indicates that the user is undesirable.

8. The method of claim 1 wherein determining when the distance between the at least one socially relevant gesture associated with the user and the content indicates that the user is undesirable includes determining when the distance indicates that the user is one selected from the group including fake, fraudulent, and/or illegitimate.

9. An apparatus comprising:
means for identifying at least one socially relevant gesture associated with a user, the at least one socially relevant gesture associated with the user being identified while the user is interacting with a system;
means for identifying at least one gesture graph that identifies content associated with at least one undesirable entity, the content including a plurality of socially relevant gestures associated with the at least one undesirable entity;
means for determining when a distance between the at least one socially relevant gesture associated with the user and the content indicates that the user is undesirable; and
means for processing the user as being undesirable when the distance indicates that the user is undesirable.

10. A computer-readable medium that includes computer code that, when executed, is operable to:
identify at least one socially relevant gesture associated with a user, the at least one socially relevant gesture associated with the user being identified while the user is interacting with a system;
identify at least one gesture graph that identifies content associated with at least one undesirable entity, the content including a plurality of socially relevant gestures associated with the at least one undesirable entity;
determine when a distance between the at least one socially relevant gesture associated with the user and the content indicates that the user is undesirable; and
process the user as being undesirable when the distance indicates that the user is undesirable.

11. The computer-readable medium of claim 10 wherein the computer code operable to determine the distance between the at least one socially relevant gesture associated with the user and the content is operable to identify a first trend associated with the at least one socially relevant gesture associated with the user, identify a second trend associated with the content, and compare the first trend with the second trend.

12. The computer-readable medium of claim 10 wherein the computer code operable to determine the distance between the at least one socially relevant gesture associated with the user and the content is further operable to compare the at least one socially relevant gesture associated with the user to the at least one gesture graph that identifies the plurality of socially relevant gestures.

13. The computer-readable medium of claim 10 wherein the computer code is further operable to:
obtain the at least one socially relevant gesture associated with the user; and
create a first gesture graph, the first gesture graph being configured to include the at least one socially relevant gesture associated with the user, wherein the logic operable to determine the distance between the at least one socially relevant gesture associated with the user and the content is further operable to compare the first gesture graph with the at least one gesture graph that identifies content associated with the at least one desirable entity.

14. The computer-readable medium of claim 13 wherein the computer code operable to obtain the at least one socially relevant gesture associated with the user is further operable to obtain the at least one socially relevant gesture associated with the user in real time, and wherein the computer code operable to determine when the distance between the at least one socially relevant gesture associated with the user and the content is further operable to determine when the distance between the at least one socially relevant gesture associated with the user and the content dynamically.

15. The computer-readable medium of claim 10 wherein the computer code operable to process the user as being undesirable when the distance indicates that the user is undesirable is further operable to prevent the user from accessing the system.

16. The computer-readable medium of claim 10 wherein the at least one gesture graph that identifies content associated with the at least one desirable entity is included in a set of gesture graphs that identify undesirable entities, the computer code being further operable to:
create a first gesture graph associated with the user, the first gesture graph including the at least one socially relevant gesture associated with the user; and
add the first gesture graph to the set of gesture graphs when the distance indicates that the user is undesirable.

17. The computer-readable medium of claim 10 wherein the computer code operable to determine when the distance between the at least one socially relevant gesture associated with the user and the content indicates that the user is undesirable is further operable to determine when the distance indicates that the user is one selected from the group including fake, fraudulent, and/or illegitimate.

18. An apparatus comprising:
a user interface, the user interface being configured to obtain socially relevant gestures made by a user;
a database, the database being arranged to store at least a first gesture graph, the first gesture graph being arranged to include information relating to at least one socially relevant gesture made by at least one identified undesirable entity; and
a processing arrangement, the processing arrangement being configured to compare the socially relevant gestures made by the user to the information included in the first gesture graph in real time to determine if the user is undesirable, the processing arrangement further being configured to process the user as being undesirable if the user is undesirable.

19. The apparatus of claim 18 wherein the processing logic is further configured to implement a verification process that allows the user access to the apparatus before the user interface obtains the socially relevant gestures made by the user.

20. The apparatus of claim 19 wherein the processing logic is further configured to create a second gesture graph, the second gesture graph being arranged to contain information relating to the socially relevant gestures made by the user.

21. The apparatus of claim 20 wherein the processing logic is further configured to store the second gesture graph in the database if the user is undesirable.
